(19) United States
(12) Patent Application Publication
(10) Pub. No.: US 2024/0391126 A1
(43) Pub. Date: Nov. 28, 2024

(54) CONTOUR CUTTING DEVICE AND METHOD

(71) Applicant: Sluis Cigar Machinery B.V., Kampen (NL)

(72) Inventor: Aalt Cornelis LOZEMAN, Laag Zuthem (NL)

(21) Appl. No.: 18/687,446

(22) PCT Filed: Sep. 2, 2022
(86) PCT No.: PCT/EP2022/074413

§ 371 Date: Feb. 28, 2024

(30) Foreign Application Priority Data
Sep. 2, 2021 (NL) 2029111

(51) Int. Cl. B26F 1/40; B26D 5/00; B26D 7/10; B26F 1/44; B65B 61/06

(52) U.S. Cl. CPC B26F 1/40; B26D 5/00; B26D 7/10; B26F 1/44; B65B 61/065; B26F 2001/4481

(57) ABSTRACT

Contour cutting system (1), in particular for cutting water-soluble pods (3), the contour cutting system comprising a controller (5), at least one cutting head (7) and at least one cutting member (9), wherein the cutting member comprises: a cutting segment (27) defining a cutting edge (37) forming a closed cutting shape (28), the cutting segment comprising a cutting conductor (31) in thermal contact with the cutting edge, the cutting conductor having a resistance chosen to allow the cutting edge to become hot as a result of a current running through the cutting conductor, wherein the contour cutting system is configured for conducting the electric cutting current from the to the cutting conductor, such that the cutting edge reaches a cutting temperature at or above a minimum suitable temperature for cutting a product from a foil (41), preferably a product comprising a water soluble pod (3) comprising PVOH.

### FIELD OF THE INVENTION

The present invention relates to the field of making pods or pouches, more specifically to cutting pods or pouches from a foil.

### BACKGROUND OF THE INVENTION

Many common household items such as detergents are commonly packaged in pods or pouches comprising a foil outer layer and an interior volume comprising a substance such as a detergent. The foil used in such pods is preferably a water-soluble foil such as polyvinyl alcohol (PVOH), in order to increase comfort of use to a user. Using a water-soluble foil, the user can use the pod or pouch without needing to unpack it first, thereby preventing contact of the user with the contents of the pod or pouch. This prevents dirty fingers and/or skin irritation.

The pods are commonly produced from large sheets of foil interconnecting multiple pods. The individual pods are then cut from the foil using multiple knives to cut the pods free from adjacent pods in a transversal direction and a longitudinal direction. This results in a roughly rectangular shape of the pods.

In order to differentiate from products already on the market, it is desirable to provide pods with a more appealing look and feel.

### OBJECT OF THE INVENTION

It is an object of the invention to provide a device and method of producing pods with a more appealing look and feel when compared to known pods.

It is a further object of the invention to provide a versatile system and method capable of manufacturing different kinds of pods.

It is a further object of the invention to provide a system and method capable of performing high quality contour cuts.

It is a further object of the invention to provide a system and method capable of with a high throughput capacity with low downtime.

### SUMMARY OF THE INVENTION

In order to achieve at least one of the objects, the invention provides a contour cutting system, in particular for cutting water-soluble pods, the contour cutting system comprising a controller, at least one cutting head and at least one cutting member,
wherein the cutting head comprises:
   a first head conductor and a second head conductor configured for conducting electric current from respective first and second controller terminals of the controller to the cutting member,
   at least one air channel, the air channel comprising an entrance arranged at the cutting member,
   a coupling device configured for releasably coupling the cutting member to the cutting head,
wherein the cutting member comprises:
   a first cutting connector and a second cutting connector for electrically contacting the first head conductor and the second head conductor, respectively,
   a cutting segment defining a cutting edge forming a closed cutting shape, the cutting segment comprising a cutting conductor in thermal contact with the cutting edge, the cutting conductor having a resistance chosen to allow the cutting edge to become hot as a result of a current running through the cutting conductor,
wherein:
   the cutting conductor is electrically connected to the first cutting connector and the second cutting connector,
   the controller is configured to provide an electric cutting current to the controller terminals,
   the contour cutting system is configured for conducting the electric cutting current from the controller terminals via the first and second head conductor and via the first and second cutting connector to the cutting conductor, such that the cutting edge reaches a cutting temperature at or above a minimum suitable temperature for cutting a product from a foil, preferably a product comprising a water soluble pod comprising PVOH.

This system allows production of pods with a different contour than the rectangular contour of known pods. The shape of the cutting edge can be any desirable closed shape, such that a pod with any desirable contour can be produced using said system. This allows making pods with a more appealing look and feel when compared to known pods.

The coupling device allows coupling various cutting members to the cutting head. This allows a versatile system capable of manufacturing differently shaped pods, seeing that the cutting member can be interchanged with a differently shaped cutting member.

The air channel allows a high quality of the contour cut because fumes and/or ashes which may be created during cutting can be removed such that they do not stain the pods.

In an embodiment:
the cutting conductor forms a closed loop of substantially the same shape as the closed cutting shape,
the closed loop comprises a first loop section and a second loop section, each loop section extending between the first cutting connector and the second cutting connector,
the contour cutting system is configured for conducting the electric cutting current such that a first portion of the current flows along the first loop section and a second portion of the current flows along the second loop section.

This provides correct heating of the entire cutting edge, such that the pod may be effectively cut from the web around the full circumference of the pod.

In an embodiment, a product of a length of the first loop section and an electric resistance of the first loop section is equal or substantially equal to a product of the length of the second loop section and a resistance of the second loop section, such that the cutting edge reaches a substantially uniform cutting temperature. This provides homogeneous cut quality around the full circumference of the pod.

In an embodiment, the controller comprises a measuring module configured for measuring an electric voltage across the cutting conductor and/or an electric current in the cutting conductor during operational use, in order to regulate a temperature in the cutting segment. This allows controlling the quality of the cut, thereby allowing optimizing for an optimal look and feel of the pod.

In an embodiment, the controller is configured to provide at intervals an electric cleaning current to the controller terminals suitable for increasing a temperature of the cutting segment to a cleaning temperature which is higher than the cutting temperature, wherein the cleaning temperature is suitable for cleaning residue from the cutting segment by burning or pyrolysis, wherein the electric cleaning current is larger than the electric cutting current. This allows regular cleaning of the cutting member, reducing fouling of the pod and elongating service life of the cutting member.

In an embodiment, the cleaning temperature is more than 50° C. above the cutting temperature, in particular more than 100° C. above the cutting temperature, more in particular more than 200° C. above the cutting temperature. Using a relatively high cleaning temperature yields fast, effective cleaning of the cutting segment by burning or pyrolysis.

In an embodiment, the coupling device is arranged to releasably clamp the first cutting connector in electronic contact with the first head conductor and to releasably clamp the second cutting connector in electronic contact with the second head conductor. This gives the system the capacity of exchanging one cutting member for another cutting member in a simple and robust way.

In an embodiment, the coupling device comprises a clamping bolt engaging a clamping nut comprising a substantially conical or frustoconical nut surface, wherein the conical or frustoconical nut surface engages a first clamping plate and a second clamping plate, which first and second clamping plate in use engage the first and second cutting connector, respectively. This advantageously allows quick exchange of one cutting member for another cutting member.

In an embodiment, at least one of the first clamping plate and the second clamping plate comprises a resilient member. This ensures good electrical contact between the cutting connectors and the head conductors.

In an embodiment, the contour cutting system comprises an airflow generating device to generate an airflow through the at least one air channel. With the airflow, any fumes and/or ashes can be sucked off and removed which results in a high quality pod without any ashes on it.

In an embodiment, the airflow generating device is arranged downstream of the air channel in the direction of the airflow.

In an embodiment, the airflow generating device is arranged at an exit of the air channel.

In an embodiment, the airflow generating device is arranged in a head mounting device which is connected to the cutting head. This allows use of a compact, light and relatively cheap cutting head.

In an embodiment, the air channel extends through the cutting head. In this way the airflow can be directed at the cutting member.

In an embodiment, the air channel, in cross-section, is an annular channel over at least part of a length thereof. This advantageously allows the airflow to be directed at the full length (or circumference) of the cutting member.

In an embodiment, the cutting head has a main axis extending orthogonally to a cutting plane defined by the cutting segment, wherein the air channel is concentric with the main axis. Advantageously, ashes can be removed over the full circumference of the cutting member.

In an embodiment, the air channel widens towards the air channel entrance.

In an embodiment, the closed loop has an average radius (D1), wherein the air channel entrance has an annular shape, wherein the average radius (D1) of the closed loop is the same as an average radius (D2) of the air channel entrance or is within a range of plus or minus 20 percent of the average radius (D2) of the air channel entrance.

In an embodiment, the air channel entrance and the closed loop have a similar shape. This ensures that the air channel entrance is near to the cutting edge around the full closed cutting shape, yielding effective cooling of the cutting segment and removal of fume and/or ashes from the cutting segment.

In an embodiment, the cutting head comprises one or more support members for supporting the cutting segment, wherein the support members extend from a bottom end of a main body of the cutting head. This prevents deformation of the cutting member as a result of the cutting operation and allows use of a lighter cutting member.

In an embodiment, the support members are arranged outwards with respect to the air channel entrance. This prevents disturbance of the airflow into the air channel entrance by the support members.

In an embodiment, the contour cutting system comprises a head mounting device for supporting the cutting head, the head mounting device being arranged above the cutting head, the cutting head being coupled to the head mounting device, wherein the contour cutting system comprises aligning means for aligning the cutting head with respect to the head mounting device in at least one translational and/or rotational direction. This ensures the cutting head is properly coupled to the head mounting device in the correct orientation.

In an embodiment, the aligning means comprise at least one magnet pair, wherein a first magnet of the magnet pair is arranged in the cutting head and a second magnet of the magnet pair is arranged in the head mounting device, wherein the first magnet and the second magnet face each other with opposite poles in a coupled position of the cutting head.

In an embodiment, the contour cutting system comprises a retaining pin arranged in one of the cutting head and the head mounting device and a retaining recess arranged in the other of the cutting head and the head mounting device, the retaining pin having an extended position and a retracted position, wherein the retaining recess is configured for receiving the retaining pin in its extended position when the cutting head is coupled to the head mounting device in a coupled position, wherein the retaining pin in its extended position in the retaining recess retains the cutting head in position relative to the head mounting device in the coupled position of the cutting head.

In an embodiment, the cutting head comprises a thermal insulation member which thermally insulates an outer surface of the cutting head from the cutting member. This allows an operator to interchange the cutting head by hand.

In an embodiment, the cutting segment comprises a rough surface finish. This reduces sticking of ash and/or foil to the cutting segment.

In an embodiment, the cutting segment is substantially symmetrical with respect to a straight symmetry line extending through a cutting plane of the cutting segment.

In an embodiment, the straight symmetry line extends between the first cutting connector and the second cutting connector.

In an embodiment, an outer surface of the cutting head comprises an inspection opening for visually inspecting engagement of the cutting member with the cutting head. This allows an operator to verify said engagement.

In an embodiment, at least one head frame, multiple cutting heads and multiple cutting members, the head frame comprising two or more mounting positions arranged along a straight mounting line, wherein a cutting head is mounted on each of the mounting positions and a cutting member is connected to each cutting head.

In an embodiment, the first cutting connector and the second cutting connector are arranged on a straight contact line extending through a cutting plane of the cutting segment, wherein the straight contact line is at an angle other than substantially parallel or substantially orthogonal to the straight mounting line, wherein the straight contact line is preferably at an angle of substantially 45 degrees or substantially 135 degrees with respect to the straight mounting line.

In an embodiment, the straight contact lines of the multiple cutting members are substantially parallel.

In an embodiment, the contour cutting system comprises:
a conveyor comprising a support surface for conveying the foil, the foil comprising the pods which are attached to one another by the foil and which are to be separated from one another by the cutting action of the cutting member, the conveyor being configured to convey the foil in a transport direction with respect to the cutting member,
a cutting drive for driving the cutting member with respect to the foil in a cutting direction towards and against the foil or vice versa to effectuate the cutting action.

In an embodiment, the cutting direction is perpendicular or substantially perpendicular to the transport direction.

In an embodiment, the conveyor comprises:
a rotating drum for conveying the foil in a curved trajectory OR
a linear conveyor for conveying the foil in a straight trajectory.

In an embodiment, the contour cutting system comprises a longitudinal drive to drive the cutting member in the transport direction concurrently with the foil during a cutting operation and in a direction substantially opposite to the transport direction in between cutting operations.

In an embodiment, the conveyor is arranged to move the pods in a continuous manner.

In an embodiment, the cutting member narrows towards the cutting edge of the cutting member.

In an embodiment, the cutting temperature is between 200° C. and 450° C., preferably between 250° C. and 400° C. Alternatively, cutting temperatures up to and over 1000° C. may be used.

In a separate aspect, the invention provides a method for cutting a water soluble pod from a foil, the method comprising the steps of:
heating a cutting edge of a cutting segment of a cutting member, the cutting edge forming a closed cutting shape, to a cutting temperature at or above a minimum suitable temperature for cutting a product from a foil by driving an electric current through a cutting conductor in thermal contact with the cutting edge,
moving the cutting edge relative to the foil to contact the foil around the pod with the heated cutting edge, thereby cutting the pod from the foil with the cutting edge,
providing an airflow past the cutting segment during cutting, thereby removing fumes and/or ashes generated during cutting.

This method provides the same advantages as the device.

In an embodiment of the method,
the cutting conductor forming a closed loop of substantially the same shape as the closed cutting shape,
the closed loop comprising a first loop section and a second loop section, each loop section extending between the first cutting connector and the second cutting connector,
   the method comprises the step of conducting the electric cutting current such that a first portion of the current flows along the first loop section and a second portion of the current flows along the second loop section.

In an embodiment, the method comprises electrically connecting the first cutting connector with a first conductor and electrically connecting the second cutting connector with a second conductor and providing an electric voltage between the first conductor and the second conductor and/or providing an electric current flowing from the first conductor to the second conductor.

In an embodiment, the method comprises providing an electric cutting current to controller terminals electrically connected to the first and second conductor.

In an embodiment, the method comprises conducting the electric current such that the first portion of the current divided by a length of the first loop section is equal or substantially equal to the second portion of the electric current divided by a length of the second loop section.

In an embodiment, the method comprises the step of providing multiple cutting segments, the method further comprising the step of cutting multiple pods from the foil simultaneously using the multiple cutting segments.

In an embodiment:
the foil is moved in a continuous manner and the cutting edge and the foil are moved synchronously during a cutting operation, OR
the foil is moved in a stepwise manner and the cutting edge and the foil are stationary during a cutting operation.

In an embodiment, the method comprises the step of controlling a temperature of the cutting edge by controlling the electric cutting current.

In an embodiment, the method comprises the step of monitoring an electric property of the cutting segment.

In an embodiment, the method comprises the step of measuring an electric voltage across the cutting segment.

In an embodiment, a cutting head is coupled to a head frame, wherein the method comprises the steps of:
uncoupling and removing the cutting head with the cutting member coupled thereto from the head frame,
coupling a different cutting head with a different cutting member coupled thereto to the head frame
   OR wherein the method comprises the steps of:
uncoupling and removing the cutting segment from the cutting head,
coupling a different cutting segment to the cutting head.

In an embodiment, the method comprises the step of coupling the cutting member to a cutting head by clamping a first cutting connector and a second cutting connector in electronic contact with a first head conductor and a second head conductor, respectively, wherein the first head conductor and the second head conductor are arranged in the cutting head.

In an embodiment, the cutting member is coupled to a cutting head, wherein the airflow is directed through an air channel which extends through the cutting head, wherein the airflow is generated by an airflow generating device, wherein the airflow through the channel cools the cutting head.

In an embodiment, the method comprises the step of, after cutting, heating the cutting segment to a cleaning temperature above the cutting temperature by running an electric cleaning current through the cutting segment, wherein the cleaning temperature is suitable for cleaning residue from the cutting segment by burning or pyrolysis, wherein the electric cleaning current is larger than the electric cutting current.

In an embodiment, said method is performed using a device of any of the preceding device embodiments.

In an embodiment of the method, the pods are detergent pods, i.e. pods filled with a detergent for doing the laundry or cleaning the dishes in a dishwasher.

These and other aspects of the invention will be more readily appreciated as the same becomes better understood by reference to the following detailed description and considered in connection with the accompanying drawings in which like reference symbols designate like parts. It will be clear to the skilled person that the features of any of the above embodiments can be combined.

### BRIEF DESCRIPTION OF THE FIGURES

Embodiments of the contour cutting device and method according to the invention will be described by way of example only, with reference to the accompanying schematic drawings in which corresponding reference symbols indicate corresponding parts, and in which:

FIG. 1 shows part of a contour cutting system according to the invention.

FIG. 2 shows a cross section of the contour cutting system part of FIG. 1.

FIG. 3 shows a bottom view of the contour cutting system part of FIG. 1.

FIGS. 4A-4D show various cutting segments of a contour cutting system according to the invention.

FIGS. 5A-5C shows a part of a contour cutting system according to the invention, comprising multiple cutting heads.

FIG. 6 shows a section of the contour cutting system part of FIGS. 5A-5C.

FIG. 7 shows a cross section of the contour cutting system part of FIG. 6.

FIGS. 8A & 8B show two possible layouts for a contour cutting system comprising multiple cutting heads.

FIG. 9 shows a part of a contour cutting system according to the invention, comprising a cutting drive and a longitudinal drive for moving the cutting head.

FIG. 10 shows an example of pods made using the contour cutting system and method according to the invention.

FIG. 11 shows an image of a section of a contour cutting system according to the invention.

FIG. 12 shows an image of a section of a contour cutting system according to the invention in the process of cutting pods.

### DETAILED DESCRIPTION OF THE FIGURES

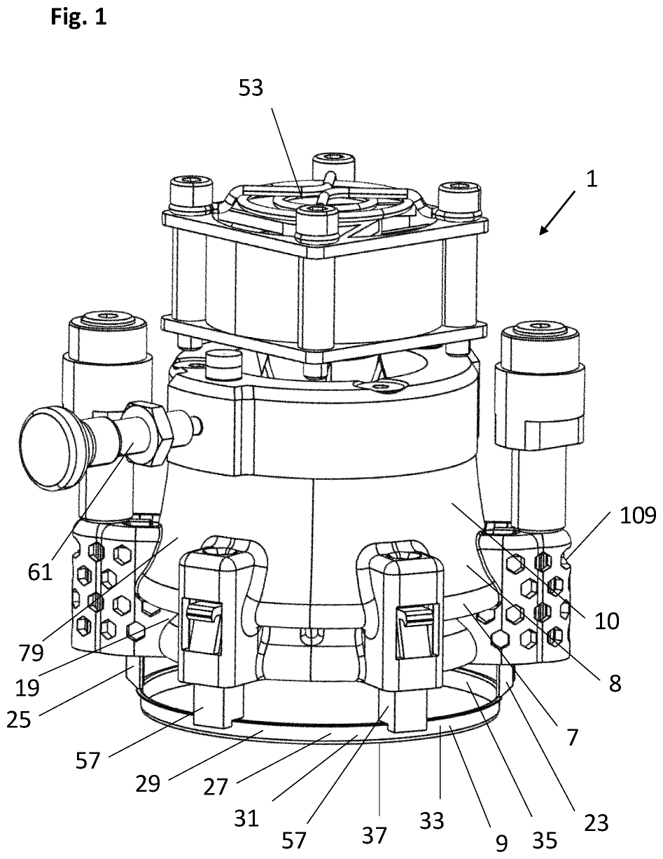

FIGS. 1-3 shows a contour cutting system 1 for cutting water-soluble pods 3 from a foil 41. The contour cutting system 1 comprises a controller 5, at least one cutting head 7 and at least one cutting member 9. The cutting head 7 comprises a first head conductor 11 and a second head conductor 13 which in use conduct electric current from respective first and second controller terminals 15A, 15B of the controller 5 to the cutting member 9. The cutting head 7 further comprises an air channel 17 comprising an entrance 19 arranged at the cutting member 9. The contour cutting system 1 comprises a coupling device 21 configured for releasably coupling the cutting member 9 to the cutting head 7. The cutting head 7 comprises a thermal insulation member 79 which thermally insulates an outer surface 10 of the cutting head 7 from the cutting member 9. Preferably, the body of the cutting head 7 is of a thermally insulating material or at least comprises a thermally insulating material, such that the body 8 of the cutting head 7 is the thermally insulating member 79.

The outer surface 10 of the cutting head 7 comprises an inspection opening 109 for visually inspecting engagement of the cutting member 9 with the cutting head 7. The cutting segment 27 may comprise a rough surface finish in order to reduce sticking of foil residue to the cutting segment 27.

The cutting edge forms a closed cutting shape 28, such that pods 3 are cut from the foil 41 around the full circumference of the pods 3. The cutting member 9 narrows towards the cutting edge 37 of the cutting member 9. This reduces fouling of the pods 3 cut from the foil 41. Due to internal tension in the foil 41 and the pods 3, the pods 3 pull away from the cutting segment 27 upon cutting. Due to the narrowing shape of the cutting member 9, contact between the side of the cutting segment 27 and the pods 3 is minimized, minimizing the chance of transfer of debris such as burnt foil material or ash from the cutting segment 27 to the pods 3. This leads to a more attractive pod 3.

The cutting member 9 further comprises a first cutting connector 23 and a second cutting connector 25 for electrically contacting the first head conductor 11 and the second head conductor 13, respectively, and a cutting segment 27 defining a cutting edge 37. The cutting segment 27 comprises a cutting conductor 31 in thermal contact with the cutting edge 37. The cutting conductor 31 has a resistance chosen to allow the cutting edge 37 to become hot as a result of a current running through the cutting segment 27. The cutting conductor 31 is electrically connected to the first cutting connector 23 and the second cutting connector 25. The controller 5 is configured to provide an electric cutting current to the controller terminals 15A, 15B, while the contour cutting system 1 is configured for conducting the electric cutting current from the controller terminals 15A, 15B via the first and second head conductor 11, 13 and via the first and second cutting connector 23, 25 to the cutting conductor 31, such that the cutting edge 37 reaches a cutting temperature at or above a minimum suitable temperature for cutting a product from a foil 41, preferably a product comprising a water soluble pod 3 comprising PVOH.

The cutting conductor 31 forms a closed loop 29 of substantially the same shape as the closed cutting shape 28. The closed loop 29 comprises a first loop section 33 and a second loop section 35, each loop section extending between the first cutting connector 23 and the second cutting connector 25. The contour cutting system 1 is configured for conducting the electric cutting current such that a first portion of the current flows along the first loop section 33 and a second portion of the current flows along the second loop section 35.

Each loop section 33, 35 extends between the first cutting connector 23 and the second cutting connector 25, wherein a product of a length of the first loop section L₁ and an electric resistance of the first loop section R₁ is equal or substantially equal to a product of the length of the second loop section L₂ and a resistance of the second loop section R₂. This ensures that the electric power per unit length that is converted into heat, Pᵢ/Lᵢ, is the same for both the first loop section 33 and the second loop section 35, seeing that Pᵢ/Lᵢ=U*Iᵢ/Lᵢ and Rᵢ=U/Iᵢ→Iᵢ=U/Rᵢ, such that Pᵢ/Lᵢ=U²/RᵢLᵢ for both the first loop section 33 and the second loop section 35, wherein Pᵢ equals the electric power converted in each loop section 33, 35, Lᵢ equals the length of each loop section 33, 35, U equals the voltage over both of the loop sections 33, 35, Iᵢ equals the electric current in each loop section 33, 35 and Rᵢ equals the resistance of each loop section 33, 35. The voltage over both of the loop sections 33, 35 is equal because they are connected in parallel to each other. The electric power per unit length that is converted into heat, Pᵢ/Lᵢ, must be equal for both of the loop sections 33, 35 to ensure that they are both heated to the same extent. This allows a uniform temperature distribution of the cutting edge 37 of the entire closed loop 29.

In use, the controller 5 provides an electric cutting current to the controller terminals 15A, 15B, while the contour cutting system 1 conducts the electric cutting current from the controller terminals 15A, 15B via the first and second head conductor 11, 13 and via the first and second cutting connector 23, 25 to the cutting segment 27. Thereby, a first portion of the current flows along the first loop section 33 and a second portion of the current flows along the second loop section 35, such that the cutting edge 37 reaches a substantially uniform cutting temperature.

the controller 5 comprises a measuring module 107 for measuring an electric voltage and/or the electric current across the cutting segment 27 during operational use, in order to regulate a temperature in the cutting segment 27, for example to maintain a constant temperature of the cutting edge 37. An increase in the current at a constant voltage, or a decrease in the voltage at a constant current, could indicate a decrease in the resistance of the cutting segment. This may be due to a decrease in the temperature of the cutting segment 27. The cutting temperature is between 200° C. and 450° C., preferably between 250° C. and 400° C. Other values may be used when appropriate, for example if a foil 41 with a melting temperature outside of this range is used. Cutting temperatures of 1000° C. or more may also be used. In use, the temperature of the cutting edge 37 is controlled by controlling the electric cutting current based on the monitoring of the voltage and/or electric current as described above.

The controller 5 may further be configured to provide at intervals an electric cleaning current to the controller terminals 15A, 15B suitable for increasing a temperature of the cutting segment 27 to a cleaning temperature which is higher than the cutting temperature, wherein the cleaning temperature is suitable for cleaning residue from the cutting segment 27 by burning or pyrolysis, wherein the cleaning current is larger than the electric cutting current. This allows removal of residue from the cutting segment 27 without interference with the contour cutting system 1 by other devices or workers. The cleaning temperature is more than 50° C. above the cutting temperature, in particular more than 100° C. above the cutting temperature, more in particular more than 200° C. above the cutting temperature.

The cutting head 7 comprises one or more support members 57 for supporting the cutting segment 27. The support members 57 extend from a bottom end of a main body 8 of the cutting head 7. The support members 57 are arranged outwards with respect to the air channel entrance 19.

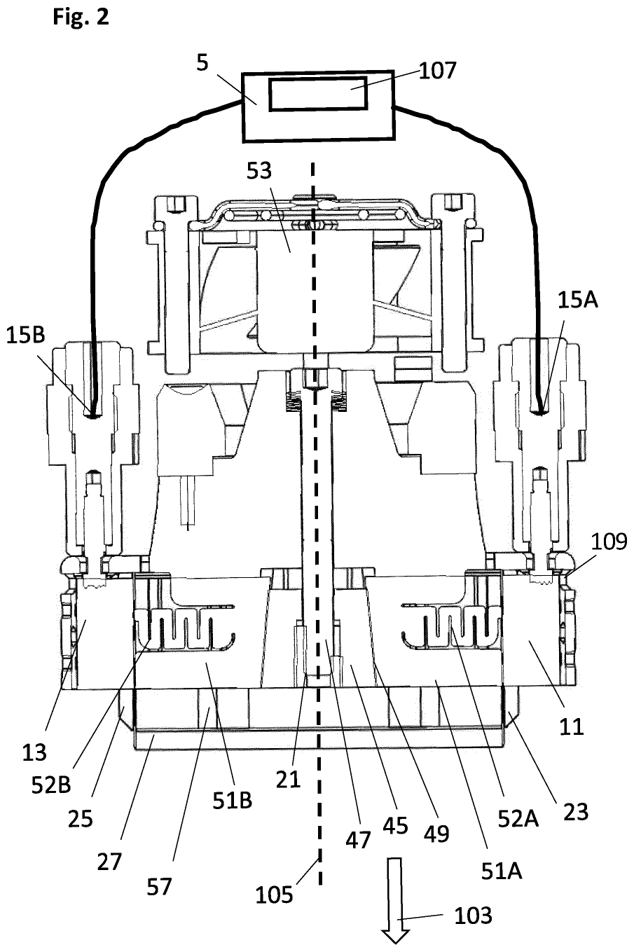

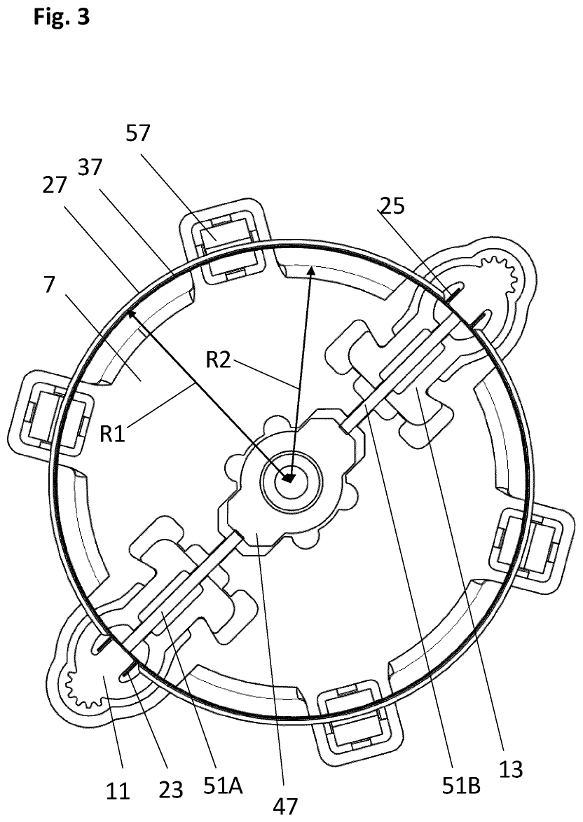

The coupling device 21 is shown in detail in FIGS. 2 and 3. The coupling device 21 releasably clamps the first cutting connector 23 in electronic contact with the first head conductor 11 and releasably clamps the second cutting connector 25 in electronic contact with the second head conductor 13. The coupling device 21 comprises a clamping bolt 45 engaging a clamping nut 47. The clamping nut 47 comprises a substantially conical or frustoconical nut surface 49, such that the conical or frustoconical nut surface 49 engages a first clamping plate 51A and a second clamping plate 51B. The first and second clamping plate 51A, 51B in use engage the first and second cutting connector 23, 25, respectively. The first clamping plate 51A and the second clamping plate 51B both comprise a resilient member 52A, 52B to allow for good engagement of both cutting connectors 23, 25 with the head conductors 11, 13.

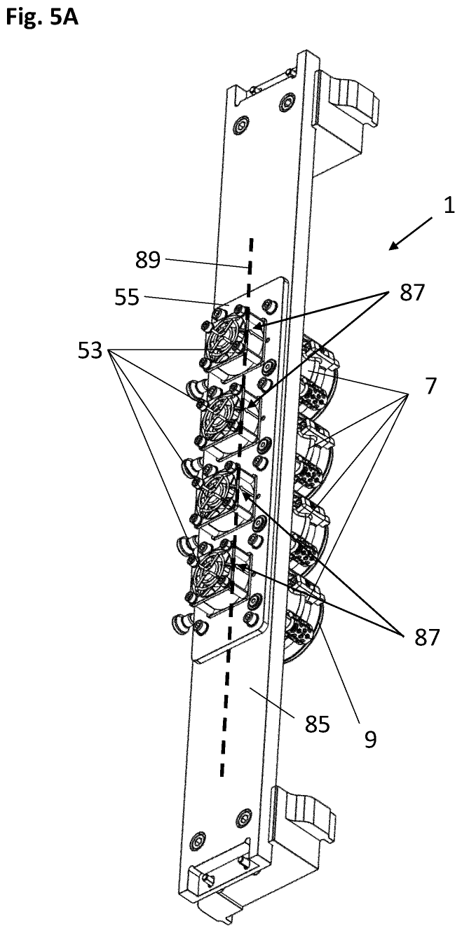

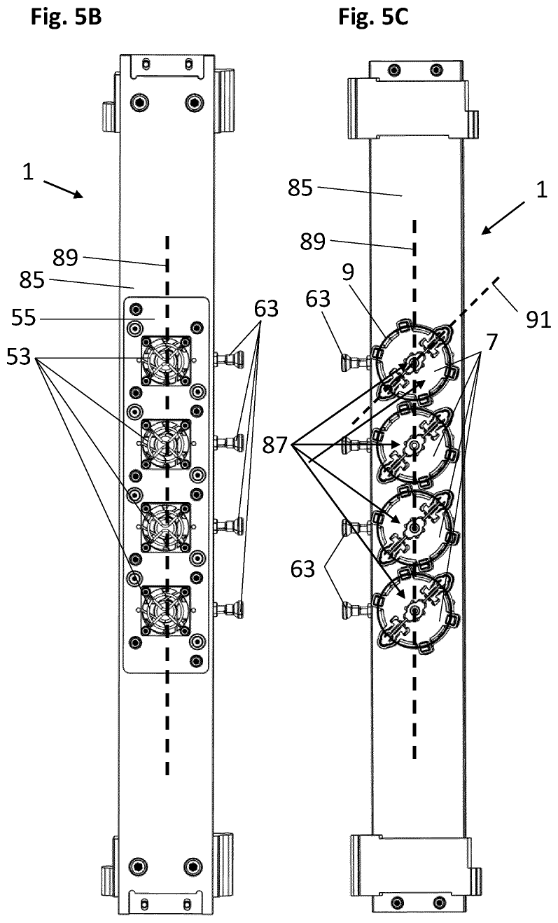

The contour cutting system 1 comprises an airflow generating device 53 to generate an airflow through the at least one air channel 17. The airflow generating device is arranged downstream of the air channel 17 in the direction of the airflow, at an exit of the air channel 17. The airflow generating device 53 is arranged in a head mounting device 55 which is connected to the cutting head 7, see FIG. 5A. The air channel 17 extends through the cutting head 7, such that air flowing through the air channel 17 cools the cutting head 7. The airflow further removes fumes and/or ashes and other debris that may be generated while cutting the foil 41.

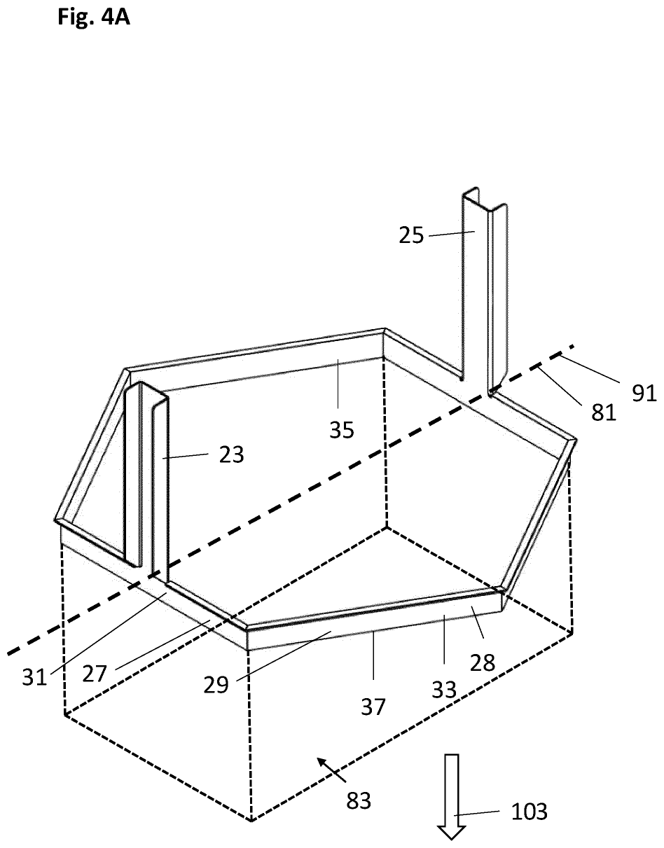

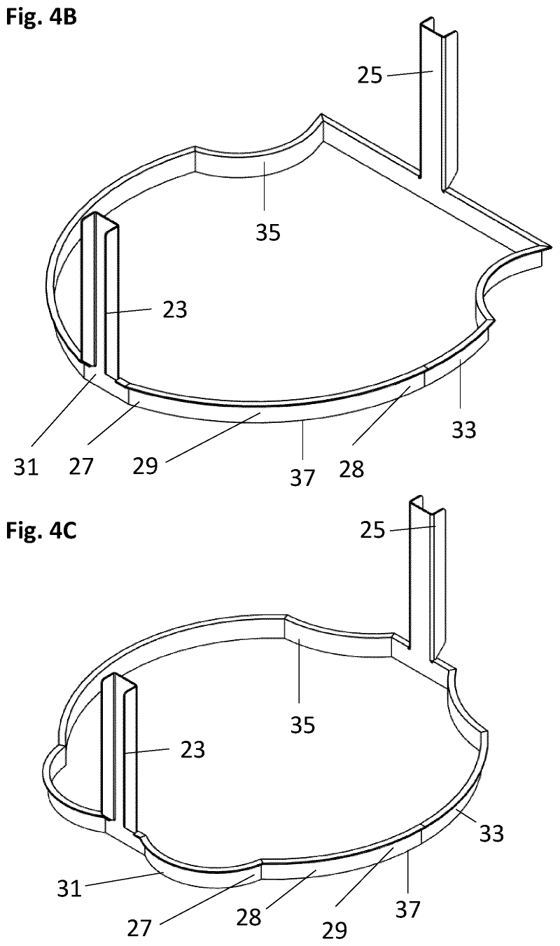

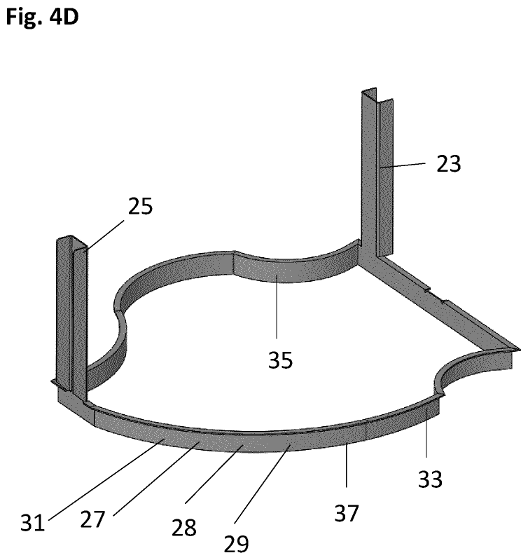

The air channel 17, in cross-section, is an annular channel over at least part of a length thereof. The cutting head 7 has a main axis 105 extending orthogonally to a cutting plane 83 defined by the cutting segment 27 (see FIG. 4A). The air channel 17 is concentric with the main axis 105. The air channel 17 widens towards the air channel entrance 19.

The closed loop 29 has an average radius D1, wherein the air channel entrance 19 has an annular shape, wherein the average radius D1 of the closed loop 29 is approximately the same as the average radius D2 of the air channel entrance 19. For a noncircular cutting segment 27, the air channel entrance 19 may be circular or another geometric shape or have a similar shape as the cutting segment 27. The average radius is the radius with respect to the main axis 105, averaged with respect to the angle according to Dⱼ=1/2π∫₀^{2π}Dⱼ(θ) dθ, wherein Dⱼ is the average radius, θ is the angle around the main axis 105 in the cutting plane 83 and dⱼ(θ) is the radius as a function of said angle.

FIGS. 4A-4D show various cutting segments 27 of embodiments according to the invention. The cutting segments 27 shown FIG. 4D is asymmetrical, the cutting segments 27 shown in in FIGS. 4A-4C are substantially symmetrical with respect to a straight symmetry line 81 extending through a cutting plane 83 of the cutting segment 27. The straight symmetry line 81 extends between the first cutting connector 23 and the second cutting connector 25. A symmetrical cutting segment 27 ensures that the first loop section 33 and the second loop section 35 have the same length. This entails that they may also have the same electrical resistance, allowing for a fully symmetrical cutting segment 27, which may ease production of the cutting segment 27.

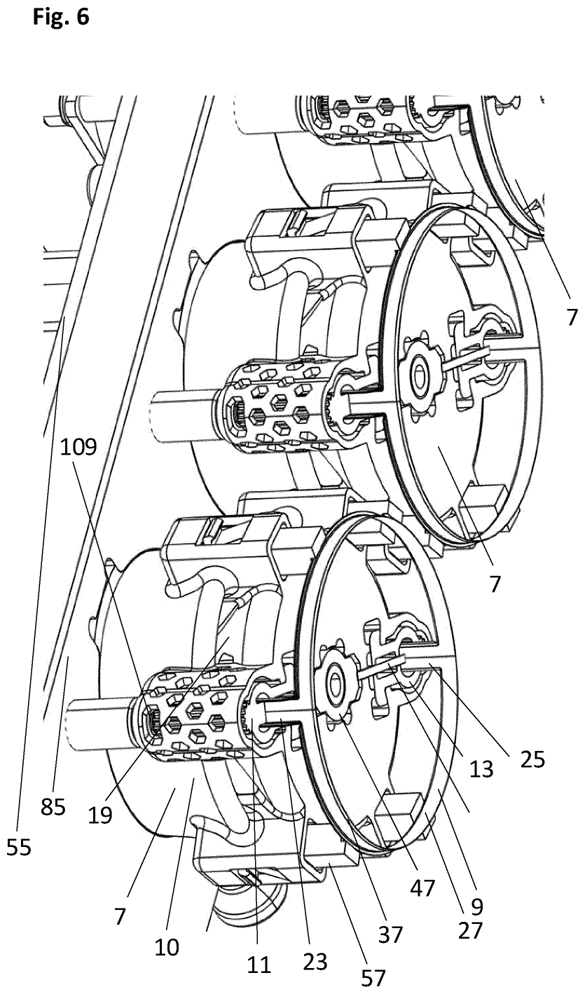

FIGS. 5A-5C and 6 show different views of a contour cutting system 1 according to the invention, comprising multiple cutting heads 7. The system 1 comprises at least a head frame 85, multiple cutting heads 7 and multiple cutting members 9, each cutting member 9 comprising a cutting segment 27. The head frame 85 comprises four mounting positions 87 arranged along a straight mounting line 89, wherein a cutting head 7 is mounted on each of the mounting positions 85 and a cutting member 9 is connected to each cutting head 7. Providing multiple cutting segments 27 allows cutting multiple pods 3 from the foil 41 simultaneously.

The first cutting connector 23 and the second cutting connector 25 are arranged on a straight contact line 91 extending through a cutting plane 83 of the cutting segment. The straight contact 91 line is at an angle other than substantially parallel or substantially orthogonal to the straight mounting line 89, wherein the straight contact line 91 is preferably at an angle of substantially 45 degrees or substantially 135 degrees with respect to the straight mounting line 89. The straight contact lines 91 of the multiple cutting members 9 are substantially parallel. This allows a compact construction, because adjacent cutting heads 7 may be placed closer together if the protrusion of the head conductors 11, 13 of adjacent cutting heads 7 do not interfere. A compact construction yields less room required, but also allows closer spacing of adjacent cutting members 9, yielding less loss of foil 41 in between the pods 3 to be cut from the foil 41.

Each cutting head 7 is coupled to a head mounting device 55 for supporting the cutting head 7. The head mounting device 55 is arranged above the cutting head 7. Aligning means 61 are included for aligning the cutting head 7 with respect to the head mounting device 55 in at least one translational and/or rotational direction.

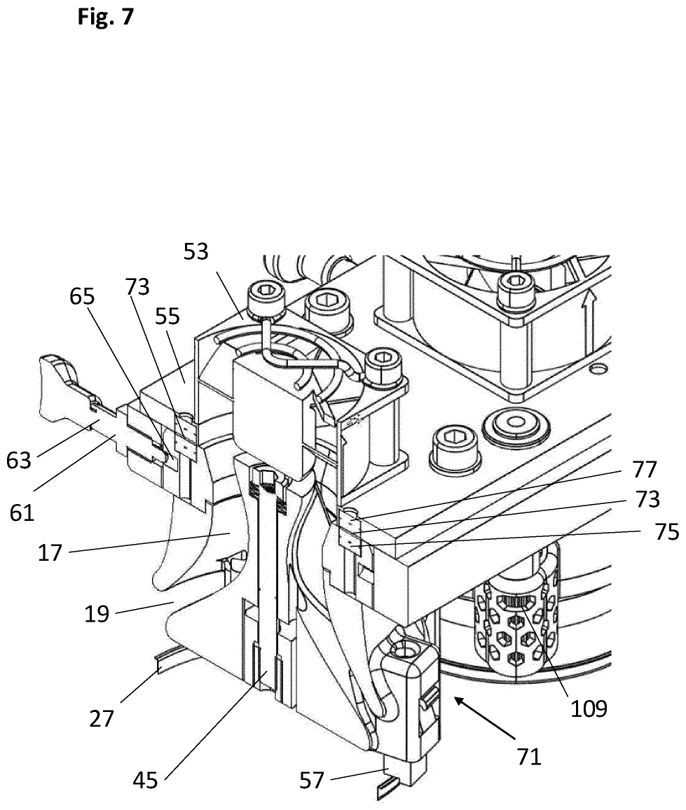

FIG. 7 shows a cross section of the contour cutting system 1 of FIGS. 5A-5C and 6. FIG. 7 shows that the aligning means 61 comprise two magnet pairs 73, wherein a first magnet 75 of the magnet pair 73 is arranged in the cutting head 7 and a second magnet 77 of the magnet pair 73 is arranged in the head mounting device 55. In the coupled position of the cutting head 7, the first magnet 75 and the second magnet 77 face each other with opposite poles. The magnets 75, 77 of the magnet pairs 73 attract each other, such that the cutting head 7 is forced towards the position wherein the magnet pairs align. This ensures proper alignment of the cutting heat 7 with respect to the head mounting device 55. The contour cutting system 1 comprises a retaining pin 63 arranged in one of the cutting head 7 and the head mounting device 55 and a retaining recess 65 arranged in the other of the cutting head 7 and the head mounting device 55. The retaining pin 63 has an extended position and a retracted position. The retaining recess 65 is configured for receiving the retaining pin 63 in its extended position when the cutting head 7 is coupled to the head mounting device 55 in a coupled position 71, such that the retaining pin 63 in its extended position in the retaining recess 65 retains the cutting head in position relative to the head mounting device 5 in the coupled position 71 of the cutting head 7.

Use of the system 1 may involve uncoupling and removing the cutting head 7 with the cutting member 9 coupled thereto from the head frame 85 and subsequently coupling a different cutting head 7 with a different cutting member 9 coupled thereto to the head frame 85. Alternatively, the cutting head 7 may be left in place on the head frame 85 while the cutting member 9 is removed from the cutting head 7 and exchanged for a different cutting member 9 to couple to the cutting head 7. Both alternatives allow an efficient way of interchanging the cutting member 9, for example if the cutting member 9 is fouled, broken or worn. Another instance where the cutting member 9 may need to be exchanged is when a different shape of pods 3 is to be produced.

The cutting member 9 is coupled to the cutting head 7 by clamping the first cutting connector 23 and the second cutting connector 25 in electronic contact with a first head conductor 11 and a second head conductor 13, respectively. Both the first head conductor 11 and the second head conductor 13 are arranged in the cutting head 7.

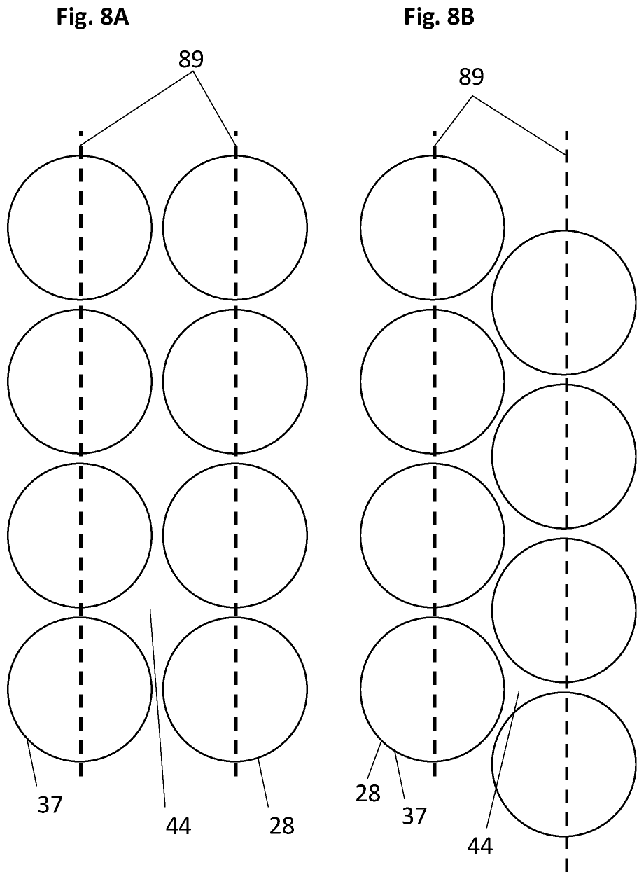

FIGS. 8A and 8B show two possible layouts for a contour cutting system 1 comprising multiple cutting heads 7 arranged along two straight mounting lines 89. A single head mounting device 55 may be used to mount all cutting heads 7, or alternatively a separate head mounting device 55 may be used for each straight mounting line 89 or even for each cutting head 7. Both FIGS. 8A & 8B are schematic depictions of the relative positions of the cutting edges 37 of the cutting members 9 coupled to each of the cutting heads 7. FIG. 8A shows a layout wherein the two groups of cutting heads 7 are aligned. This allows ease of construction. FIG. 8B shows a layout wherein the cutting heads 7 are placed in a staggered arrangement. This allows a more compact construction and reduces wasted foil 44, because the pods 3 can be placed closer together in the foil 41, such that less foil 41 is present in between the pods 3. The foil 41 in between the pods 3 is discarded as waste after cutting the pods 3, so minimizing the amount of wasted foil 44 is attractive from an economical perspective.

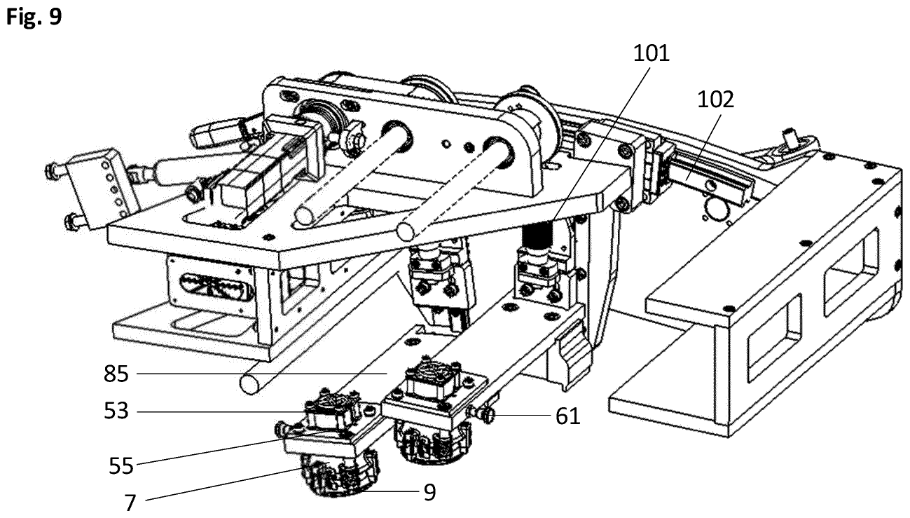

FIG. 9 shows a contour cutting system 1 comprising a cutting drive 101 and a longitudinal drive 102. The cutting drive 101 drives the cutting member 9 coupled to the cutting head 7 with respect to the foil 41 in the cutting direction 103 to effectuate a cutting action. The cutting direction 103 is parallel to the main axis 105. The longitudinal drive 102 drives the cutting member 9 coupled to the cutting head 7 in the transport direction 104 concurrently with the foil 41 during the cutting operation and in a direction substantially opposite to the transport direction 99 in between cutting operations. This allows use of a conveyor 95 that moves the foil 41 and the pods 3 in a continuous manner, allowing use of a continuously moving production line. The cutting direction 103 is substantially perpendicular to the transport direction 99, or at least comprises a component that is substantially perpendicular to the transport direction 99 at the position where the pods 3 are cut from the foil 41. The conveyor 95 may comprise a rotating drum for conveying the foil 41 along a curved trajectory or a linear conveyor for conveying the foil 41 along a straight trajectory.

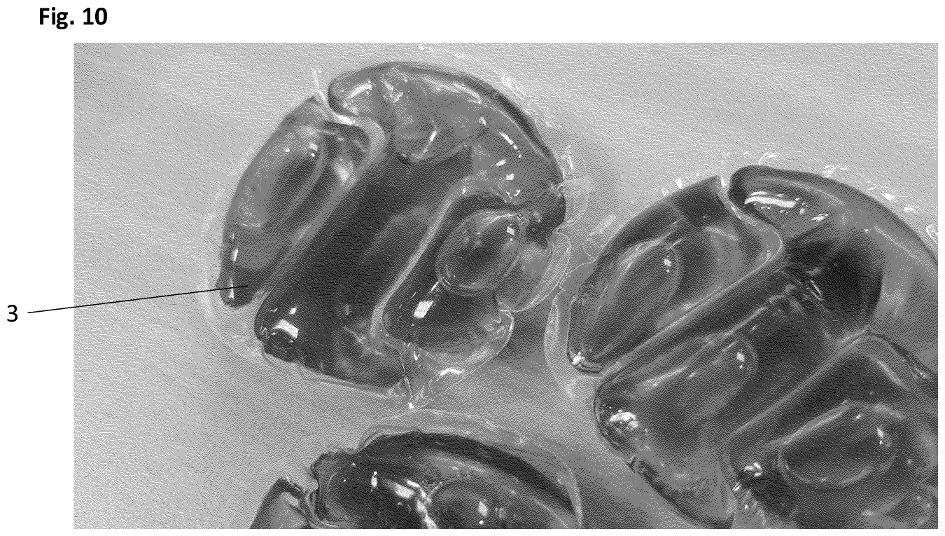

FIG. 10 shows an example of pods 3 made using the contour cutting system 1 and method according to the invention. For these pods 3, a round cutting edge 37 is used. The skilled person will understand that the invention is suitable to create pods 3 with various shapes, for instance cartoon or animal figures, logos of brands, etc. The pod 3 contains detergent, but may also contain other substances such as food or medicaments.

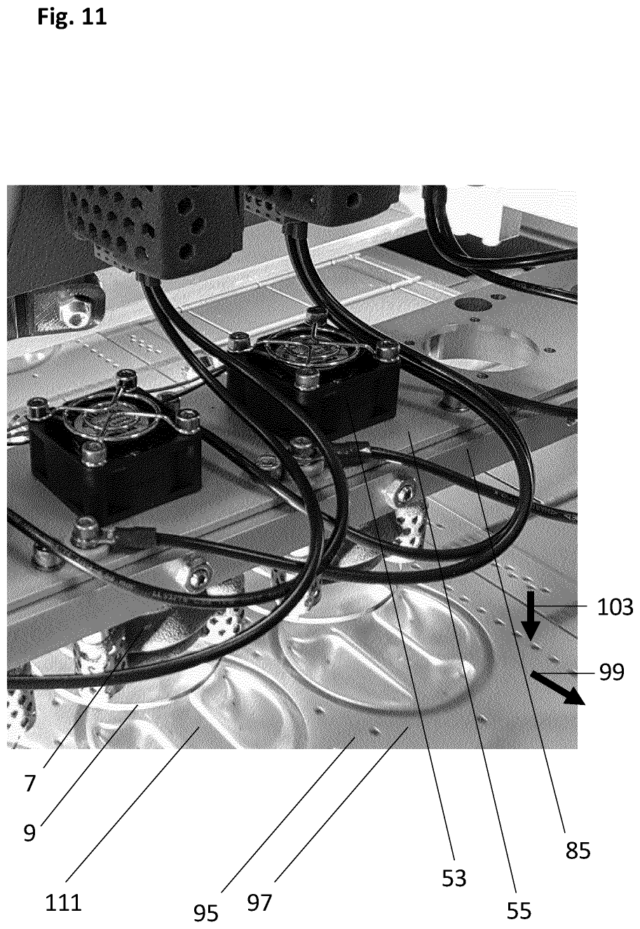

FIG. 11 shows an image of a section of a contour cutting system 1 according to the invention. The cutting head 7, cutting member 9, airflow generating device 53, head mounting device 55, head frame 85, conveyor 95, and the support surface 97 are shown. The transport direction 99 and cutting direction 103 are also indicated, as are the moulds 111 in which the pods 3 are held in use.

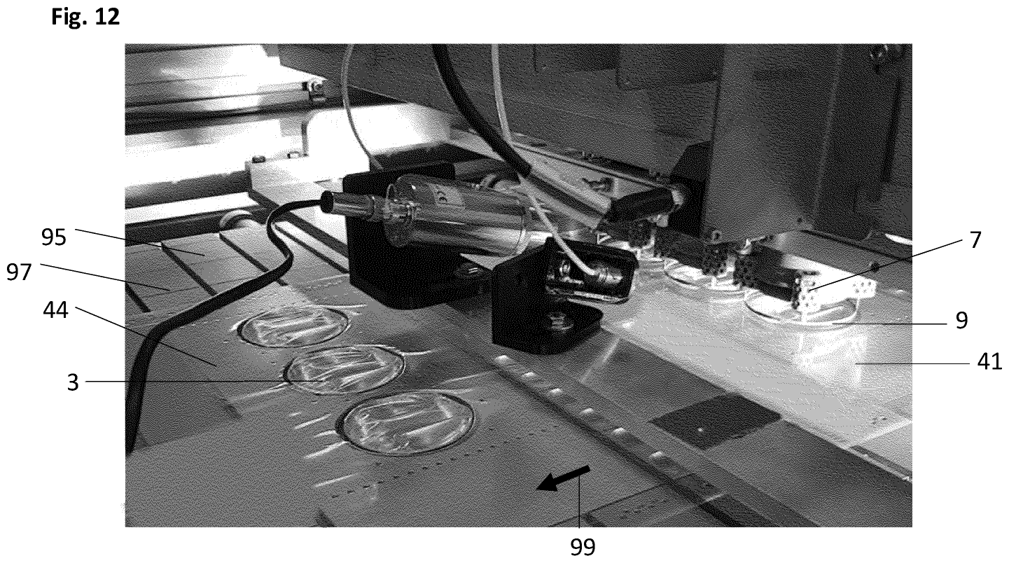

FIG. 12 shows an image of a section of a contour cutting system 1 according to the invention in the process of cutting pods 3 from the foil 41. The foil 41 and pods 3 are supported on the support surface 97 of the conveyor 95.

The term “foil” as used in this document describes a thin sheet of any suitable material. PVOH is described as a potential material, but other types of water-soluble materials, notably water-soluble polymers, could also be used.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

The mere fact that certain measures are recited in mutually different dependent claims does not indicate that a combination of these measures cannot be used to advantage.

1.-54. (canceled)

55. A contour cutting system, in particular for cutting water-soluble pods, the contour cutting system comprising a controller, at least one cutting head and at least one cutting member,
wherein the cutting head comprises:
a first head conductor and a second head conductor configured for conducting electric current from respective first and second controller terminals of the controller to the cutting member,
at least one air channel, the air channel comprising an entrance arranged at the cutting member, and
a coupling device configured for releasably coupling the cutting member to the cutting head,
wherein the cutting member comprises:
a first cutting connector and a second cutting connector for electrically contacting the first head conductor and the second head conductor, respectively, and
a cutting segment defining a cutting edge forming a closed cutting shape, the cutting segment comprising a cutting conductor in thermal contact with the cutting edge, the cutting conductor having a resistance chosen to allow the cutting edge to become hot as a result of a current running through the cutting conductor,
wherein:
the cutting conductor is electrically connected to the first cutting connector and the second cutting connector,
the controller is configured to provide an electric cutting current to the controller terminals, and
the contour cutting system is configured for conducting the electric cutting current from the controller terminals via the first and second head conductor and via the first and second cutting connector to the cutting conductor, such that the cutting edge reaches a cutting temperature at or above a minimum suitable temperature for cutting a product from a foil, preferably a product comprising a water soluble pod comprising PVOH.

56. The contour cutting system according to claim 55, wherein:
the cutting conductor forms a closed loop of substantially the same shape as the closed cutting shape,
the closed loop comprises a first loop section and a second loop section, each loop section extending between the first cutting connector and the second cutting connector, and
the contour cutting system is configured for conducting the electric cutting current such that a first portion of the current flows along the first loop section and a second portion of the current flows along the second loop section.

57. The contour cutting system according to claim 56, wherein a product of a length of the first loop section and an electric resistance of the first loop section is equal or substantially equal to a product of the length of the second loop section and a resistance of the second loop section, such that the cutting edge reaches a substantially uniform cutting temperature.

58. The contour cutting system according to claim 55, wherein the controller is configured to provide at intervals an electric cleaning current to the controller terminals suitable for increasing a temperature of the cutting segment to a cleaning temperature which is higher than the cutting temperature, wherein the cleaning temperature is suitable for cleaning residue from the cutting segment by burning or pyrolysis, wherein the electric cleaning current is larger than the electric cutting current.

59. The contour cutting system according to claim 55, wherein the coupling device is arranged to releasably clamp the first cutting connector in electronic contact with the first head conductor and to releasably clamp the second cutting connector in electronic contact with the second head conductor.

60. The contour cutting system according to claim 55, further comprising an airflow generating device to generate an airflow through the at least one air channel.

61. The contour cutting system according to claim 55, further comprising a head mounting device for supporting the cutting head, the head mounting device being arranged above the cutting head, the cutting head being coupled to the head mounting device, wherein the contour cutting system comprises aligning means for aligning the cutting head with respect to the head mounting device in at least one translational and/or rotational direction.

62. The contour cutting system according to claim 55, further comprising a retaining pin arranged in one of the cutting head and the head mounting device and a retaining recess arranged in the other of the cutting head and the head mounting device, the retaining pin having an extended position and a retracted position, wherein the retaining recess is configured for receiving the retaining pin in its extended position when the cutting head is coupled to the head mounting device in a coupled position, wherein the retaining pin in its extended position in the retaining recess retains the cutting head in position relative to the head mounting device in the coupled position of the cutting head.

63. The contour cutting system according to claim 55, wherein the cutting segment comprises a rough surface finish.

64. The contour cutting system according to claim 55, further comprising at least one head frame, multiple cutting heads and multiple cutting members, the head frame comprising two or more mounting positions arranged along a straight mounting line, wherein a cutting head is mounted on each of the mounting positions and a cutting member is connected to each cutting head.

65. The contour cutting system according to claim 55, further comprising:
a conveyor comprising a support surface for conveying the foil, the foil comprising the pods which are attached to one another by the foil and which are to be separated from one another by the cutting action of the cutting member, the conveyor being configured to convey the foil in a transport direction with respect to the cutting member, and
a cutting drive for driving the cutting member with respect to the foil in a cutting direction towards and against the foil or vice versa to effectuate the cutting action.

66. The contour cutting system according to claim 65, further comprising a longitudinal drive to drive the cutting member in the transport direction concurrently with the foil during a cutting operation and in a direction substantially opposite to the transport direction in between cutting operations.

67. A method for cutting a water soluble pod from a foil, the method comprising the steps of:
heating a cutting edge of a cutting segment of a cutting member, the cutting edge forming a closed cutting shape, to a cutting temperature at or above a minimum suitable temperature for cutting a product from a foil by driving an electric current through a cutting conductor in thermal contact with the cutting edge,
moving the cutting edge relative to the foil to contact the foil around the pod with the heated cutting edge, thereby cutting the pod from the foil with the cutting edge, and
providing an airflow past the cutting segment during cutting, thereby removing fumes and/or ashes generated during cutting.

68. The method according to claim 67,
the cutting conductor forming a closed loop of substantially the same shape as the closed cutting shape,
the closed loop comprising a first loop section and a second loop section, each loop section extending between a first cutting connector and a second cutting connector,
the method further comprising the step of conducting the electric cutting current such that a first portion of the current flows along the first loop section and a second portion of the current flows along the second loop section.

69. The method according to claim 68, the method further comprising conducting the electric current such that the first portion of the current divided by a length of the first loop section is equal or substantially equal to the second portion of the electric current divided by a length of the second loop section.

70. The method according to claim 67, the method further comprising the step of controlling a temperature of the cutting edge by controlling the electric current.

71. The method according to claim 67, wherein a cutting head is coupled to a head frame, wherein the method further comprises the steps of:
uncoupling and removing the cutting head with the cutting member coupled thereto from the head frame,
coupling a different cutting head with a different cutting member coupled thereto to the head frame, or
wherein the method comprises the steps of:
uncoupling and removing the cutting member from the cutting head,
coupling a different cutting member to the cutting head.

72. The method according to claim 67, wherein the cutting member is coupled to a cutting head, wherein the airflow is directed through an air channel which extends through the cutting head, wherein the airflow is generated by an airflow generating device, wherein the airflow through the air channel cools the cutting head.

73. The method according to claim 67, the method further comprising the step of, after cutting, heating the cutting segment to a cleaning temperature above the cutting temperature by running an electric cleaning current through the cutting segment, wherein the cleaning temperature is suitable for cleaning residue from the cutting segment by burning or pyrolysis, wherein the electric cleaning current is larger than the electric cutting current.

74. The method according to claim 67, wherein said method is performed using the contour cutting system of claim 55.
